(19) United States
(12) Patent Application Publication
(10) Pub. No.: US 2012/0133074 A1
(43) Pub. Date: May 31, 2012

(54) METHOD FOR MAKING WASTE COLLECTION TUBE

(76) Inventors: Jeffrey A. Pitas, Macedon, NY (US); Kevin H. Blakely, Rochester, NY (US); Francisco L. Ziegelmuller, Penfield, NY (US)

(21) Appl. No.: 12/956,021

(22) Filed: Nov. 30, 2010

(51) Int. Cl. B29C 45/14

(52) U.S. Cl. 264/241

(57) ABSTRACT

A method for making a waste collection tube for a dry electrophotographic printer includes molding an open construction waste tube which has mirror construction symmetry. A first half and a second half of the open construction waste tube are joined by a flexible hinge. The first half and the second half of the open construction waste tube is folded together along the hinge which joins the first half and the second half together.

### CROSS REFERENCE TO RELATED APPLICATIONS

Reference is made to commonly-assigned copending U.S. patent application Ser. No. ______ (Attorney Docket No. 96697/NAB), filed herewith, entitled WASTE COLLECTION TUBE HAVING A LIVING HINGE, by Pitas et al.; the disclosure of which is incorporated herein.

### FIELD OF THE INVENTION

The present invention relates to electrophotography in general, and in particular to a method of making a waste collection tube for an electrophotographic printer.

### BACKGROUND OF THE INVENTION

The electrophotographic process creates an image on paper or other suitable printing media. An electrophotographic printer is comprised of components assembled into a print engine.

The primary material used for printing purposes is toner. During the printing process not all of the toner transfers to the print media. Some of this toner may be unsuitable for transfer, but is present in the toner supply, or some of the toner may be intended to be discarded as part of the normal process. When this residual material is produced it is necessary to transport the material to a collection point. A waste transport device is used for this purpose. Sealing of the waste transport device is critical to prevent leakage and subsequent contamination of the machine.

A primary component of a waste transport device is the waste collection tube. Manufacturers glue or ultrasonically weld the parts of the waste collection tube together. This process is labor intensive, expensive, and prone to leakage if the attachment is imperfect.

Some manufacturers make collection tubes in two parts and then glue or ultrasonically weld the parts together. Great care must be taken to ensure that leakage does not occur. Often tube joints need to be wrapped or otherwise have the seals reinforced to prevent leakage.

### SUMMARY OF THE INVENTION

Briefly, according to one aspect of the present invention a method for making a waste collection tube for a dry electrophotographic printer includes molding an open construction waste tube which has mirror construction symmetry. A first half and a second half of the open construction waste tube are joined by a flexible hinge. The first half and the second half of the open construction waste tube is folded together along the hinge which joins the first half and the second half together.

In the present invention, the two halves of the waste collection tube are attached to each other by a “living hinge” that allows them to flex together during construction and assembly. The flexible seam or hinge is located at the bottom of the assembly in an auger cavity which is the area that is most prone to leakage.

The hinge is made by molding the two halves of the assembly as one flexible piece, using a plastic or similar material. The joint between the two parts is sufficiently thin so as to allow the joint to flex without cracking. Having the living hinge in the portion of the cavity where leakage would be most likely to occur is unique and produces unexpected results. This method eliminates tooling required in more commonly practiced sealing techniques. For example, specifically designed ultrasonic horns or gluing fixtures are not needed when practicing the present invention.

The invention and its objects and advantages will become more apparent in the detailed description of the preferred embodiment presented below.

### BRIEF DESCRIPTION OF THE DRAWINGS

FIG. 1 is a cross-section of an electrophotographic print module.

FIG. 2 is a cross-section of an electrophotographic print module cartridge with interface hardware.

FIG. 3 is a waste transport device.

FIG. 4 is a waste transport device with internal detail.

FIG. 5 is a waste transport device showing assembly process.

FIG. 6 is a waste transport device showing assembly process.

FIG. 7 is a waste transport device showing assembly process.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

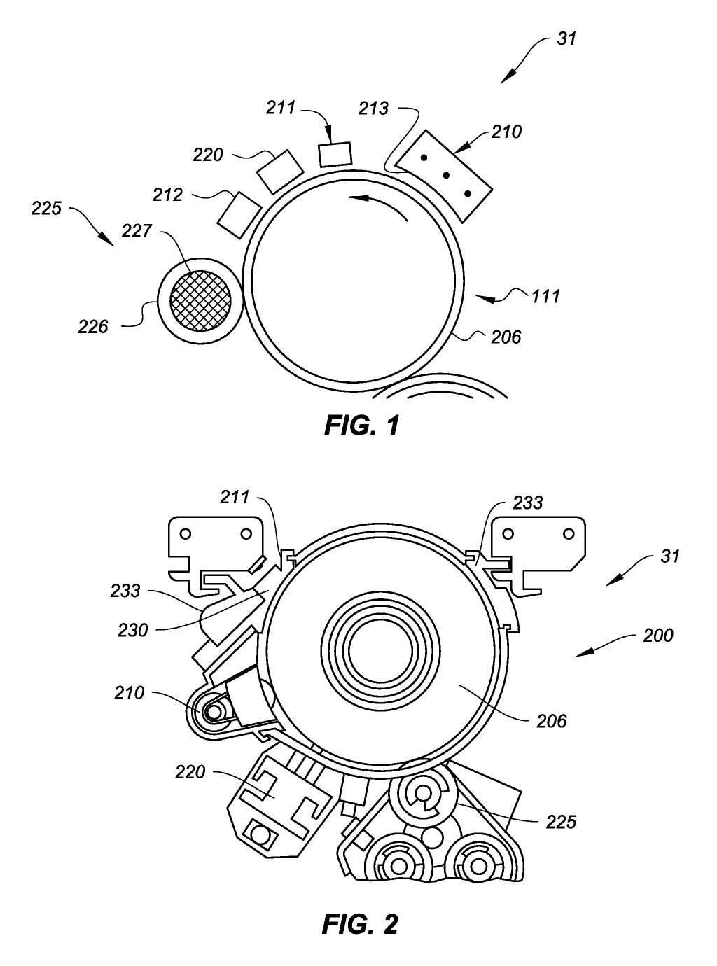

Referring now to FIG. 1, an electrophotographic printer includes components necessary to print an image on paper. A printer is comprised of various sub-assemblies which perform specific functions.

An imaging module in the printer consists of components to enable printing of a single color image. Multiple modules may be assembled to enable the printing of multiple color images. FIG. 1 shows details of a typical printing module 31, which may be assembled with other imaging modules to enable printing multiple colors.

Primary charging subsystem 210 uniformly electrostatically charges photoreceptor 206 of photoreceptive member 111, shown in the form of an imaging cylinder. Charging subsystem 210 may include a grid 213 having a selected voltage, or may be in the form of a roller with conductive properties.

Additional necessary components provided for control may be assembled around the various process elements of the respective printing modules. Meter 211 measures the uniform electrostatic charge provided by charging subsystem 210, and meter 212 measures the post-exposure surface potential within a patch area of a latent image formed from time to time in a non-image area on photoreceptor 206.

Image writer 220 is used to expose photoreceptor 206 and may be a light emitting diode (LED) array or other similar mechanisms or laser. Toning unit 225, comprising elements 226 and 227, is used to develop the latent image created by image writer 220 on photoreceptor 206. Cleaning unit 230 removes residual toner from photoreceptor 206 after transfer of the image to a secondary receiver. Other meters and components may be included.

Within the imaging module 31, periodic replacement of critical components is necessary to ensure proper function. It may be desired to cluster multiple components to enable simultaneous replacement.

Referring to FIG. 2, shown here with a change in form, is one such cluster, referred to as a replacement cartridge 200 within imaging module 31 consisting of a photoreceptive member 111, cleaning system 230, and charging subsystem 210. These components are assembled into a cartridge and held in place with a plastic housing 233.

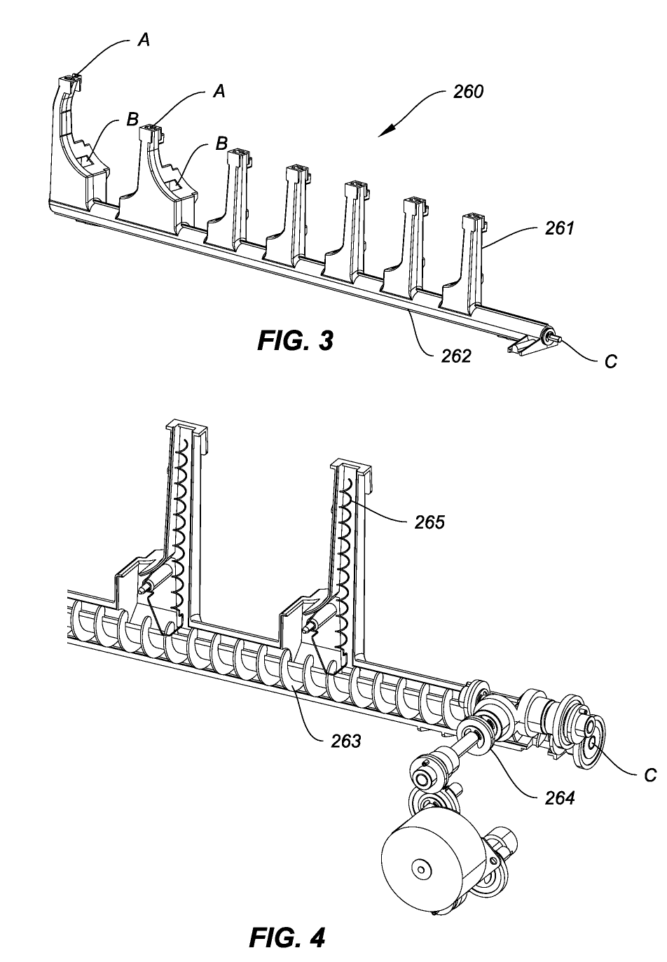

Referring now to FIG. 3 a waste transport device 260 is shown. The waste transport device consists of collection tube 261 and transport tube 262. Residual toner waste from cleaning unit 230 and toning unit 225 leave those devices and drop into the waste transport device at points A and B. The waste transport device 260 collects and combines the residual waste toner into a common waste stream which exits the waste transport device 260 at point C. Referring now to FIG. 4, within the transport tube 262 is a screw auger 263 which turns through the use of a drive device 264. The drive device 264 may take many forms, either through direct coupling, or with a belt drive or gear drive arrangement. The drive turns the screw auger 263 and transports the residual toner waste to a convenient collection point C. The screw auger 263 may or may not enter a waste collection bottle at point C.

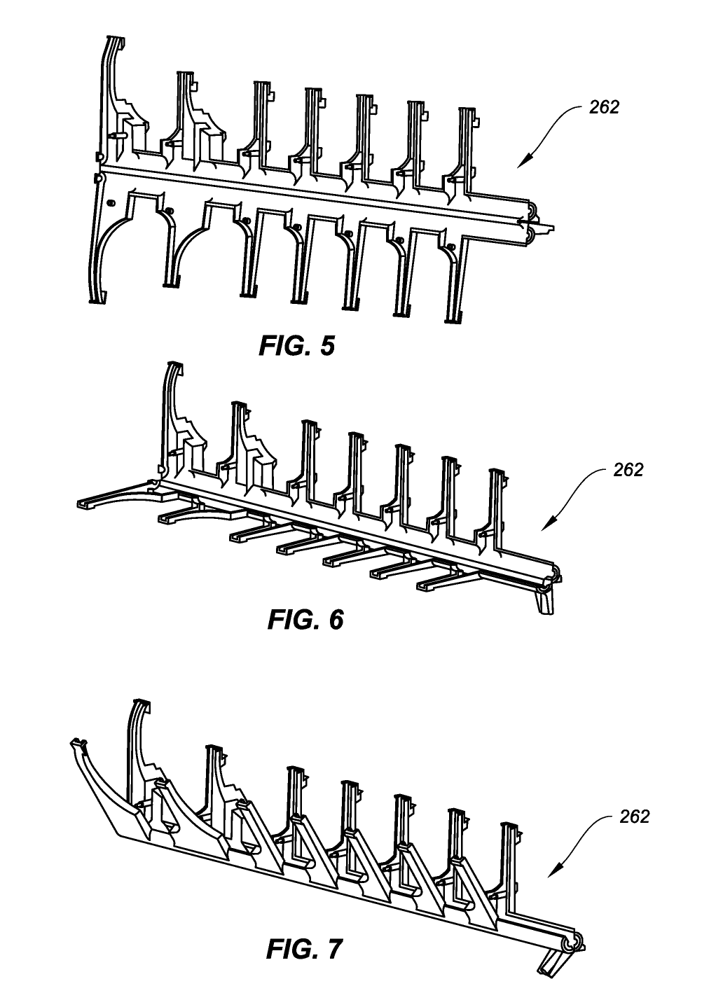

Referring now to FIGS. 5-7 shows a means of construction of the waste transport device 260 with the final step shown in FIG. 3. The waste collection device must be sealed to prevent contamination escaping and entering the print engine. The critical location for leakage is at the base of the transport tube, which through gravity and transport of the toner by screw auger 263, tends to open the assembly joint and contaminate the print engine. The design of the waste tube integrates a living hinge along a long length of the transport tube 262 which creates an intrinsic seal when assembled. The hinged edge must be flexible in order to fold during assembly without fracturing. Typical materials chosen for such applications are polyethylene, polypropylene, polystyrene, or polyester.

The design of the device is such that the long length is created substantially vertical at the base of the transport tube, which is the most critical point for leakage. Other less critical joints are created with overlapping plastic labyrinth features to seal, and snap features or fasteners to retain the assembly. As leakage possibility in these other locations is far less likely, less positive sealing means are required.

Such a waste transport device depends upon additional parts for the transport of toner. Typically components included in the assembly include an auger, rattlers, bearing, springs, gates, shut off, or combinations thereof. Alignment features are included in the first half of the transport tube such that components are easily inserted in the first half of the open construction prior to joining the first half to the second half. The flexible hinge along the long length of the tube aids assembly by providing precise alignment when folded.

Other designs in similar electrophotographic equipment comprise two separate pieces with glued, ultrasonically welded or screwed construction with sealing tapes. Assembly of the tube and various components within requires precise locating techniques. The construction of the waste collection device outlined is less costly than traditional two piece constructions and offers ease of disassembly for reuse purposes.

The invention has been described in detail with particular reference to certain preferred embodiments thereof, but it will be understood that variations and modifications can be effected within the scope of the invention.

### PARTS LIST

31 printing module
111 photoreceptive member
200 replacement cartridge
206 photoreceptor
210 charging subsystem
211 meter
212 meter
213 grid
220 image writer
225 toning unit
226 element
227 element
230 cleaning unit
233 plastic housing
260 waste transport device
261 collection tube
262 transport tube
263 screw auger
264 drive device

1. A method for making a waste collection tube for a dry electrophotographic printer comprising:
molding an open construction waste tube;
wherein the open construction waste tube has mirror symmetry;
wherein a first half and a second half of the open construction waste tube are joined by a flexible hinge;
folding the first half and the second half of the open construction waste tube together along the hinge; and
joining the first half and the second half together.

2. The method of claim 1 wherein the edges of the first half and the second half open construction waste tube has edges having labyrinth seals.

3. The method of claim 1 wherein an auger, rattler, bearing, springs, gates, shut off, or combinations thereof are inserted in the first half of the open construction prior to joining the first half to the second half.

4. The method of claim 1 wherein the waste tube comprises polyethylene, polypropylene, polystyrene, or polyester.

5. The method of claim 1 wherein a fastening device attaches the first half to the second half in a removable manner.
